(19) United States
(12) Patent Application Publication
(10) Pub. No.: US 2012/0231434 A1
(43) Pub. Date: Sep. 13, 2012

(54) In-Desk Tablet PC and Classroom Automation System

(76) Inventor: Rodney Standage, Gilbert, AZ (US)

(21) Appl. No.: 13/046,440

(22) Filed: Mar. 11, 2011

(51) Int. Cl. G09B 5/00

(52) U.S. Cl. 434/350

(57) ABSTRACT

An open-systems classroom information technology automation solution that allows a teacher to control features and content on multiple student workstations (an in-desk Tablet PC) through a wireless network and server solution, including hardware, software and network subsystems. The custom product components include a compact self contained in-desk or in-table Tablet PC with input/output port extender. The custom software utilities and applications allow a teacher console to control access to various components and commercially available applications on the student workstations (an in-desk Tablet PC). Other custom software utilities allow the administrator to easily configure student workstations (an in-desk Tablet PC) making add/change/deletes quick and simple.

### SPECIFICATIONS

| | |
|---|---|
| Name | Rodney Standage |
| Citizenship | USA |
| Address | 2800 E Bridgeport Court |
| | Gilbert, AZ 85295 |
| Title of the | In-Desk Tablet PC and Classroom Automation System |
| Invention | |
| Cross Reference | |
| to Related | |
| Applications | |

### CROSS-REFERENCE TO RELATED APPLICATIONS

| | | |
|---|---|---|
| 7,667,962 | February 2010 | Mullen |
| 7,656,393 | February 2010 | King, et al. |
| 7,639,484 | December 2009 | Chen, et al. |
| 7,639,237 | December 2009 | Perkins |
| 7,630,193 | December 2009 | Ledbetter, et al. |
| 7,614,008 | November 2009 | Ording |
| 7,599,561 | October 2009 | Wilson, et al. |
| 7,557,816 | July 2009 | Kuroki |
| 7,545,627 | June 2009 | Lantigua |
| 7,519,389 | April 2009 | Mizumake, et al. |
| 7,511,703 | March 2009 | Wilson, et al. |
| 7,543,244 | June 2009 | Matthews, et al. |
| 7,506,592 | March 2009 | Rossini |
| 7,502,222 | March 2009 | Cheng, et al. |
| 7,502,220 | March 2009 | Shudo, et al. |
| 7,493,018 | January 2009 | Oliver |
| 7,480,139 | January 2009 | Ryder, et al. |
| 7,477,508 | January 2009 | Pilkington, et al. |
| 7,454,228 | November 2008 | Mizumaki, et al. |
| 7,451,942 | November 2008 | Peng |
| 7,398,408 | July 2008 | Paljug |
| 7,352,565 | April 2008 | Yin |
| 7,281,698 | October 2007 | Patterson, Jr |
| 7,215,538 | May 2007 | Chen, et al. |
| 7,206,198 | April 2007 | Wang |
| 7,203,058 | April 2007 | Hong |
| 7,198,327 | April 2007 | Bergin |
| 7,173,814 | February 2007 | Cohen, et al. |
| 7,173,603 | February 2007 | Kawasome |
| 7,168,813 | January 2007 | Wong, et al. |
| RE39429 | December 2006 | Hawkins, et al. |
| 7,130,186 | October 2006 | Yu |
| 7,091,961 | August 2006 | Ditzik |
| 7,061,753 | June 2006 | Michoux, et al. |
| 7,054,965 | May 2006 | Bell, et al. |
| 7,054,963 | May 2006 | Betts-LaCroix, et al. |
| 7,042,400 | May 2006 | Pryor, et al. |
| 7,017,988 | March 2006 | Tornero, et al. |
| 7,009,594 | March 2006 | Wang, et al. |
| 6,985,356 | January 2006 | Wang |
| 6,971,624 | December 2005 | Kollar, et al. |
| 6,963,487 | November 2005 | Billington, et al. |
| 6,962,311 | November 2005 | Sykes |
| 6,956,614 | October 2005 | Quintana, et al. |
| 6,914,197 | July 2005 | Doherty, et al. |
| 6,874,429 | April 2005 | Bosman, et al. |
| 6,856,506 | February 2005 | Doherty, et al. |
| 6,817,587 | November 2004 | Lin |
| 6,609,465 | August 2003 | Kolavo |
| 6,486,868 | November 2002 | Kazarian |
| 6,474,760 | November 2002 | Rauls |
| 6,366,935 | April 2002 | Hawkins, et al. |
| 6,301,101 | October 2001 | Anzai, et al. |
| 6,256,193 | July 2001 | Janik, et al. |
| 6,247,815 | June 2001 | Inova |
| 6,237,507 | May 2001 | Yanagisawa, et al. |
| 6,129,681 | April 2001 | Hawkins, et al. |
| 6,064,373 | May 2000 | Ditzik |
| 6,021,535 | February 2000 | Baus, et al. |
| 5,915,661 | June 1999 | Silverman, et al. |
| 5,899,421 | May 1999 | Silverman |
| 5,492,068 | February 1996 | McKee |
| 20080192424 | August 2008 | Lee; Chung-yi |
| 20070211036 | September 2007 | Perkins; Michael T. |
| 20070090638 | April 2007 | Severi Rivera; Renato Severino |
| 20060082518 | April 2006 | Pam; Pranil |
| 20060037987 | February 2006 | Lin; Jui-Ching |
| 20050178298 | August 2005 | Possini, Alfred P. |
| 20050045072 | March 2005 | Rossini, Alfred P. |
| 20040160738 | August 2004 | Chen, Ching-Jou; et al. |
| 20040017652 | January 2004 | Billington, Corey A.; et al. |
| 20030235029 | December 2003 | Doherty, John; et al. |
| 61/913,332 | July 2005 | Berterfield, et al. |
| 6,760,748 | July 2004 | Hakim |
| 6,683,394 | January 2004 | Gevaert |
| 20030062777 | April 2003 | Oppitz, Mauricio Bohrer |
| 20030028588 | February 2003 | McConnell, Evan; et al. |
| 7,147,284 | December 2006 | Mills, et al. |
| 7,198,327 | April 2007 | Bergin |
| 6,286,440 | September 2001 | Jyringi |
| 5,452,950 | September 1995 | Crenshaw, et al. |
| 5,628,255 | May 1997 | Neuner |
| 5,957,059 | September 1999 | Burhman |
| 5,961,192 | October 1999 | Bernart, et al. |
| 20060293048 | December 2006 | Swanson; Mark R.; et al. |
| 20050244803 | November 2005 | Brown, Benny R; et al. |
| 20050088816 | April 2005 | Zodnik, Richard; et al. |
| 20020097567 | July 2002 | Zodnik, Richard; et al. |
| 20030062777 | April 2003 | Oppitz, Mauricio Bohrer |
| 4,735,467 | April 1988 | Wolters |
| 5,452,950 | September 1995 | Crenshaw, et al. |
| 5,896,817 | April 1999 | Hancock |
| 5,957,059 | September 1999 | Burhman |
| 6,022,087 | February 2000 | Gilbert |
| 6,059,385 | May 2000 | Guhl |
| 6,092,883 | July 2000 | Lechman |

### STATEMENT REGARDING FEDERALLY SPONSORED RESEARCH OR DEVELOPMENT

Not Applicable.

### BACKGROUND OF THE INVENTION

The education industry is setting right at the crossroads of major innovation. Teachers and administrators are asking for affordable technology. The marketplace has tremendous potential for educational solutions. The problem is there isn't an affordable platform on which to deliver the content.

Today there are primarily three options for computer automation on the student desktop.
1) They include the standard desktop PC with a vertical monitor
2) The Laptop PC which includes various Tablet PC models and
3) Handheld input response units.

In the classroom, the standard desktop PC is affordably priced, but it is large and consumes excessive power. The monitor creates a barrier between the student and the teacher and lacks multiple input methods desirable for a full featured educational platform.

The laptop and Tablet PC have many desirable features that enhance the educational experience. However, it is relatively expensive, especially considering how easily mobile devices are broken or lost.

The handheld input response units are affordable. They are typically a single application, unidirectional peripheral device with highly restricted capabilities. They lack a flexibility of being used with multiple applications and can soon be rendered useless with the next new application.

There are many technology companies that need a platform to run their solutions. Today this platform tends to be a single user response unit that allows students to respond to questions, but is usually a single application peripheral. Other platforms are Desktop PCs found in the computer lab. These applications tend to focus on learning to use the PC, not using the PC to teach subjects. The learning activity might take place in the computer lab, not the classroom.

These platforms are not multi-input devices and are not flexible enough to provide all of the learning modalities necessary for today's classroom. They don't necessarily eliminate the need of printed learning material or an expense lowering paper-free or textbook free educational experience.

The product concept is an in-desk multi-media tablet PC pen/touch system that is tied back to a server via an in classroom secure-wireless system. It allows teachers to push curriculum to the desks of each student. It would allow a teacher to test for understanding through out a presentation and provide immediate feedback for individual mentoring.

The complete system includes a central server, wireless web-security enabled firewall, multiple in-desk configured tablet PCs and a single mobile tablet PC for the teacher.

The Tablet PC is based on the Microsoft Corp Tablet PC definition http://www.microsoft.com/presspass/features/2000/nov00/11-13tabletpc.mspx) including dual pen and touch solutions of those provided by companies like Wacom (http://www.wacom-components.com/products/MultiTouch/) or N-Trig (http://www.n-trig.com/Content.aspx?Page=AboutUs).

### BRIEF SUMMARY OF THE INVENTION

The product concept is an in-desk multi-media tablet PC pen/touch system that is tied back to a server via an in classroom secure-wireless system. It allows teachers to push curriculum to the desks of each student. It would allow a teacher to test for understanding through out a presentation and provide immediate feedback for individual mentoring.

The complete system includes a central server, wireless web-security enabled firewall, multiple in-desk configured tablet PCs and a single mobile tablet PC for the teacher.

The Tablet PC is based on the Microsoft Corp Tablet PC definition http://www.microsoft.com/presspass/features/2000/nov00/11-13tabletpc.mspx) including dual pen and touch solutions of those provided by companies like Wacom (http://www.wacom-components.com/products/MultiTouch/) or N-Trig (http://www.n-trig.com/Content.aspx?Page=AboutUs).

The Tablet PC that is integrated into a student desk can be manufactured at a lower cost than mobile devices. The mobile power system and custom compact peripherals are not needed. The robust frame is not needed because the desk structure provides strength and protection. An integrated device is less likely broken or lost than a mobile device. This lowers the total cost of ownership of the device over its lifetime.

The Server is an industry standard server running Microsoft small business server software and manufactured by companies like HP and Dell.

The wireless solution provides secure connections between the teacher's console and the student Tablet PCs. The solutions are available from companies such as Cisco and Sonicwall.

### BRIEF DESCRIPTION OF THE SEVERAL VIEWS OF THE DRAWING

The drawings show representations of the in-desk Tablet PC and various desktop and classroom configurations. These drawing are representative of various embodiments and are not to be understood as a comprehensive selection of available configurations.

FIG. 1 is a drawing which shows a cross sectional view of the proposed Tablet PC in a desktop and the placement of the I/O port expander attached at the edge on the under side.

FIG. 2 is a drawing of the top view of a desktop showing the desk, Tablet PC.

FIG. 3 is a drawing showing a side view of a front hinge configuration. This represents the possible configuration described in the specification.

FIG. 4 is a drawing showing a classroom configuration with the teacher's console the firewall and server product stack and ten student desks.

FIG. 5 is a drawing showing two rows of a four station table configuration. The Tablet PC is embedded into the tabletop in front of each seat.

FIG. 6 is a picture representation of a Tablet PC in the desktop. It also shows an I/O port extender in the upper corner.

FIG. 7 are pictures of several student desks. The desks in these pictures are representative of the type of desks that will be used to install the custom Tablet PC.

FIG. 8 is a drawing showing a front hinge desktop configuration.

FIG. 9 is a picture showing another mounted multiple desk configuration. Multiple Tablet PCs would be installed into the desk, one at each seat.

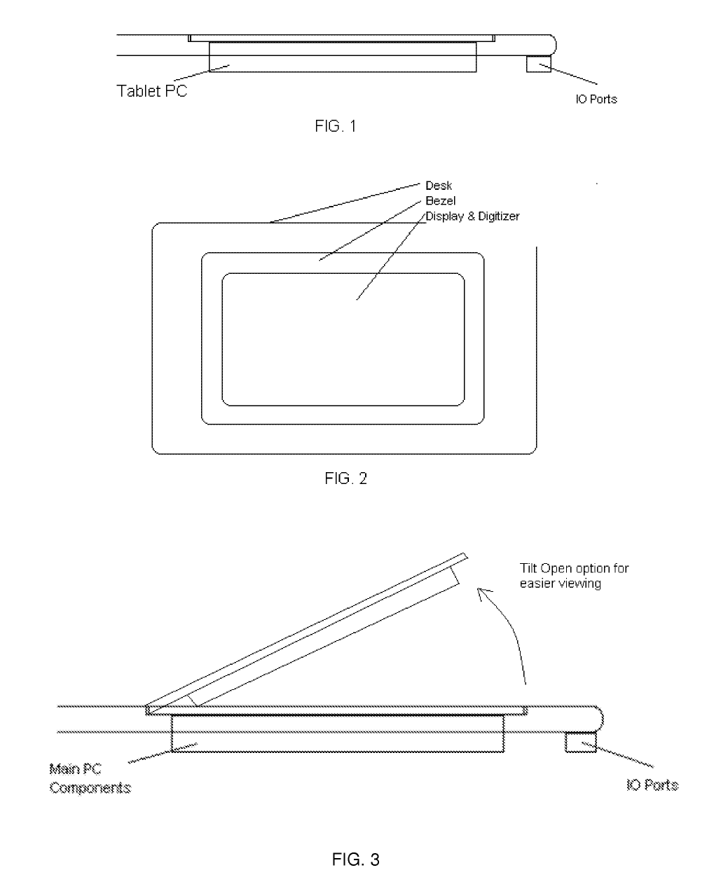

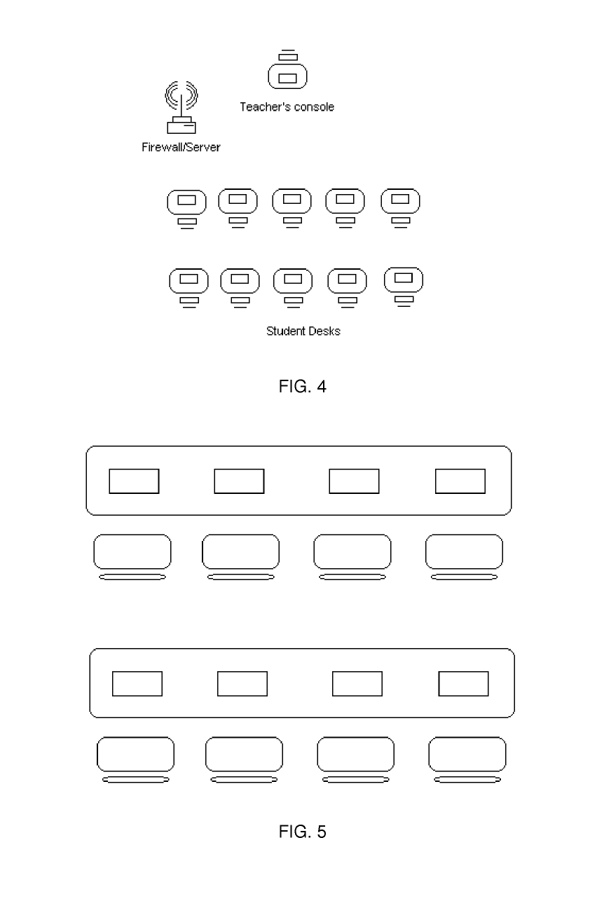

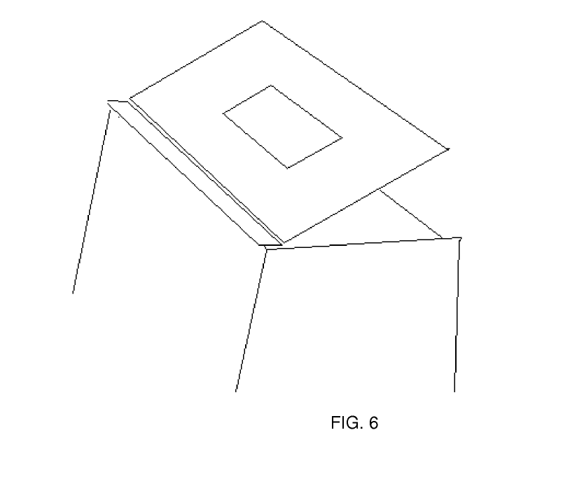

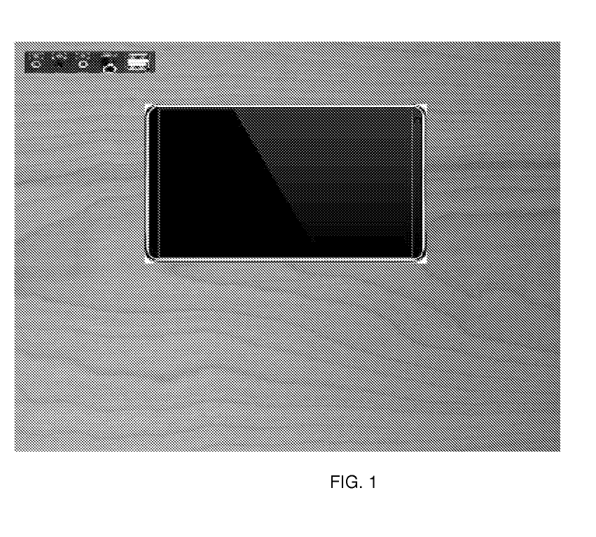

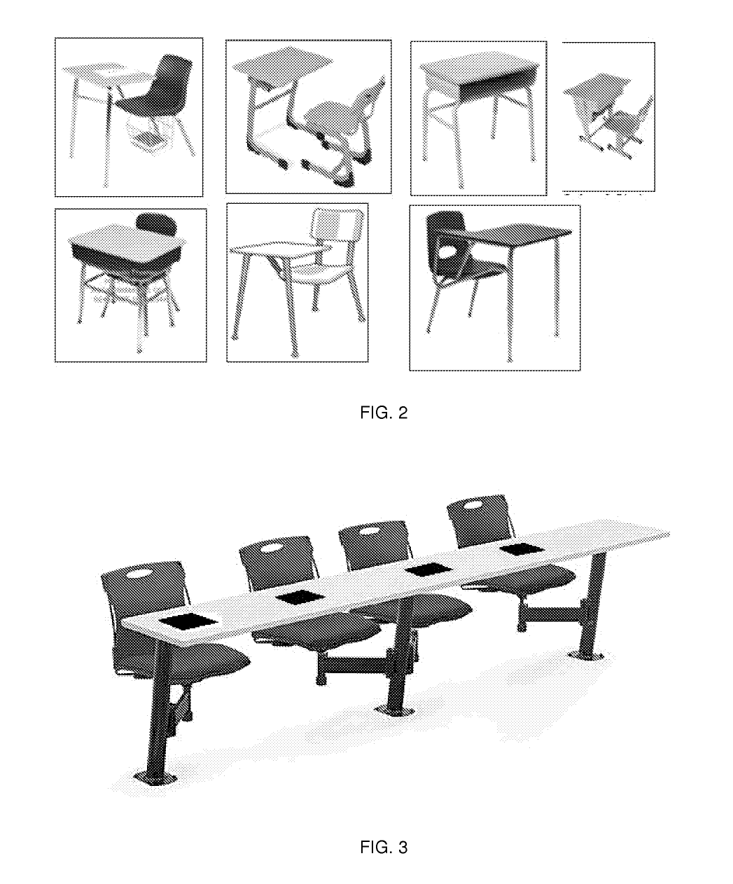

### DETAILED DESCRIPTION OF THE INVENTION

The education industry is setting right at the crossroads of major innovation. Teachers and administrators are asking for affordable technology. The marketplace has tremendous potential for educational solutions. The problem is there isn't an affordable platform on which to deliver the content.

Today there are primarily three options for computer automation on the student desktop.

1) They include the standard desktop PC with a vertical monitor

2) The mobile laptop PC which includes various mobile Tablet PC models and

3) Handheld input response units.

In the classroom, the standard desktop PC is affordably priced, but it is large and consumes excessive power. The monitor creates a barrier between the student and the teacher and lacks multiple input methods desirable for a full featured educational platform.

The laptop and Tablet PC has many desirable features that enhance the educational experience. However, it is relatively expensive, especially considering how easily they are broken or lost.

The handheld input response units are affordable. They are typically a single application, unidirectional peripheral device with highly restricted capabilities. They lack a flexibility of being used with multiple applications and can soon be rendered useless with the next new application.

There are many technology companies that need a platform that runs their solutions. Today this platform tends to be a single user response unit that allows students to respond to questions, but is usually a single application peripheral. Other platforms are Desktop PCs found in the computer lab. These applications tend to focus on learning to use the PC, not using the PC to teach subjects. The learning activity might take place in the computer lab, not the classroom.

These platforms are not multi-input devices and are not flexible enough to provide all of the learning modalities necessary for today's classroom. They don't necessarily eliminate the need of printed learning material or an expense lowering paper-free or textbook free educational experience.

The product concept is an in-desk multi-media tablet PC pen/touch system that is tied back to a server via an in classroom secure-wireless system. It allows teachers to push curriculum to the desks of each student. It would allow a teacher to test for understanding through out a presentation and provide immediate feedback for individual mentoring.

The complete system includes a central server, wireless web-security enabled firewall, multiple in-desk configured tablet PCs and a single mobile tablet PC for the teacher.

The Tablet PC is based on the Microsoft Corp Tablet PC definition http://www.microsoft.com/presspass/features/2000/nov00/11-13tabletpc.mspx) including dual pen and touch solutions of those provided by companies like Wacom (http://www.wacom-components.com/products/MultiTouch/) or N-Trig (http://www.n-trig.com/Content.aspx?Page=AboutUs).

Our product innovation will provide a stratified product and service offering that can meet the needs of various budgets and feature requirements.

The product will provide the custom in-desk PC product, classroom wireless network and server solution. Desk and PC integration services and existing desk retrofit services will be supported and delivered both at the factory and on-site. Customer service, product warranty and support services will be coordinated from regional offices. Primary method of hardware break-fix support will be the use of hot spares and next day product exchange. We will also provide on going research and development for product improvement and new feature implementation.

A custom non-portable Tablet PC would be installed into a standard student desk. The horizontal in-desk configuration would pose less of a distraction during classroom instruction. The teacher controls the display of each student system, turning the monitor on only when needed. The desktop could be covered with an opaque covering to allow the desk to be used for crafts or other projects while protecting the PC from spills or damage when the system was not in use. A port extender would bring IO ports within easy access to the student and be installed on the under side of the desk. The port extender would allow connection of an optional keyboard, mouse or other peripheral device to the Tablet PC. The in-desk configuration would protect the PC from accidental damage, loss and theft at a much lower cost than a standard portable Tablet PC in a laptop configuration.

The desktop and chair could be made from recycled plastics.

There is also the option of hinging the front of the device or the front of the desktop to allow the display to tilt for an easier reading or research configuration.

The Tablet PC: A pen and touch enabled Tablet PC would allow for a multi-input system that could allow for a broad range of educational experiences. The pen could be tethered to the tabletop. A pen caddie option allows the teacher to account for and store the Tablet PC pens.

Other features include a theft prevention alarm or notification if the Tablet PC were removed from the wireless network.

Software: Learning activities can be easily customized by a teacher, provide instant feedback to the teacher while the students are engaged in the activity so the teacher can provide individualized topical instructions to students struggling with concepts.

The teacher's console can control the access to each application. It would allow one to enable or disable access to control learning methods at the desktop.

An easy configuration option will auto configure active PCs in the network. This makes it easy to add, change and delete.

The application could change the teacher's focus from grading tests and homework assignments to creating interesting and interactive learning experiences to motivate and inspire learning.

Secure Remote Access: The system includes SRA connectivity options for students to connect from home to receive and submit assignments from their home PCs.

Bundled applications include
Word processor
Spreadsheet
Presentation
Text Aloud
Survey Monkey type testing program
e-Reader
e-Ink art program
others

The system would be completely compatible with various PC and server based educational solutions such as e-Whiteboards, Black Board, Genesis, SIRS, Home Logic, Teacher Logic, and others. This is an open systems platform that will allow schools to leverage existing technology investments. It is also a development platform that many technology solution providers can use to distribute their solutions.

1. An open-systems information technology classroom automation solution that allows a teacher to control features and content on multiple student workstations through a wireless network and server solution, including hardware, software and network subsystems.

2. Hardware. The classroom automation system hardware includes the following components:
(a) Multiple Student Workstations. A single student workstation is required for each student, the total number is variable and is one of many custom tablet PCs installed in student desks or tables, comprising in combination:
i. a flush mounted custom built tablet PC in a rectangular desktop in a single student desk or a rectangular table top for multiple units and seats;
ii. a rectangular cutout in the desk or table top to accommodate a flush surface mounted custom tablet PC; wherein the cutout is rectangular and is centered left to right and top to bottom or offset left to right and or top to bottom depending on desired configuration;
iii. an attached custom input/output (I/O) port extender installed on the underside of the desk near a front, side or rear edge for easy access to peripheral connectors, power-on and other buttons;
iv. a custom built tablet PC contains commercially available integrated touch and pen subsystem allowing data and pointer input directly without the need of a keyboard or other input device also other necessary computer subsystems such as motherboard, expansion cards, network interface controller for LAN/WAN/Cellular connectivity, power supply, disk drives, memory and other components and are self contained in the tablet PC module;
v. a custom tablet PC in a desk module wherein the custom tablet PC fits into a cutout and bevel and is attached to the desk or table top by brackets;
vi. the custom tablet PC in a desk module wherein the custom tablet PC is operational in both stand alone and classroom solution integration mode;
vii. the custom tablet PC in a desk module wherein the keyboard, mouse pointer and other peripheral devices are optional based on the required configuration and connected through the custom IO port extender;
viii. a front desk top hinge for optional desktop tilting or a front edge custom tablet PC hinge for custom tablet PC tilting for ergonomic adjustment.
(b) Teacher Console. The teacher console is a commercially available portable tablet PC with all of the features of the student workstations and added control applications as required.
(c) Server. The server is a commercially available small business server which allows the teacher console and student workstations to store data and access server based applications and utilities as necessary.
(d) Wireless Firewall. The commercially available wireless firewall will provide wireless network connectivity, security and bandwidth management capability.

3. Software. The custom software applications will run on the server, teacher's console and student workstations and have the following features:
(a) the console will control student workstation hardware features (such as enabling and disabling the display and touch panel modules)
(b) the console will control software applications and utilities running on the student workstations
(c) server based auto configure utility will allow easy set up and changes to the teacher's console and student workstations.

4. Network. The network will be managed through wired and wireless connections by a commercially available wireless firewall in combination with the server, teachers console and student workstations wired and wireless controllers, have security features including Intrusion Prevention Services, Anti-Virus, Anti-Spyware and Content Filter Services and provide other connectivity and bandwidth management services as available.
